(19) United States
(12) Patent Application Publication
(10) Pub. No.: US 2025/0315766 A1
(43) Pub. Date: Oct. 9, 2025

(54) ARTIFICIAL INTELLIGENCE COMPUTING DEVICE FOR IMPROVING BUSINESS PERFORMANCE

(71) Applicant: Nigel Mansson, Port Angeles, WA (US)

(72) Inventor: Nigel Mansson, Port Angeles, WA (US)

(21) Appl. No.: 18/625,386

(22) Filed: Apr. 3, 2024

(51) Int. Cl. G06Q 10/0637

(52) U.S. Cl. CPC G06Q 10/06375

(57) ABSTRACT

A computing device for making business decisions to improve business performance includes a processor and a memory coupled to the processor. The memory stores computer-readable instructions that, upon execution by the processor, configure the processor to receive business data comprising various business parameters from a data processing device and determine, via an artificial intelligence (AI) module, a business decision which the AI module predicts will alter at least one of the business parameters to improve performance of a business associated with the business data.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to artificial intelligence-based analytical devices and more particularly pertains to a new artificial intelligence-based analytical device for making business decisions to improve business performance.

### (2) Description of Related Art Including Information Disclosed Under 37 CFR 1.97 and 1.98

The prior art relates to artificial intelligence-based analytical devices to analyze business data and make various strategic and operational decisions for a business to improve performance. Such devices require a user to submit a prompt, a goal, a question, or the like for the device to solve a particular problem. However, the prior art fails to describe such an advice which monitors computers on a network for changes in business data and provides business decisions via an artificial intelligence module in response to such changes.

### BRIEF SUMMARY OF THE INVENTION

An embodiment of the disclosure meets the needs presented above by generally comprising a processor and a memory coupled to the processor. The memory stores computer-readable instructions that, upon execution by the processor, configure the processor to receive business data comprising various business parameters from a data processing device and determine, via an artificial intelligence (AI) module, a business decision which the AI module predicts will alter at least one of the business parameters to improve performance of a business associated with the business data.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a computing device according to an embodiment of the disclosure.

FIG. 2 is a front detail view of an embodiment of the disclosure.

FIG. 3 is a block diagram of an embodiment of the disclosure.

### DETAILED DESCRIPTION OF THE INVENTION

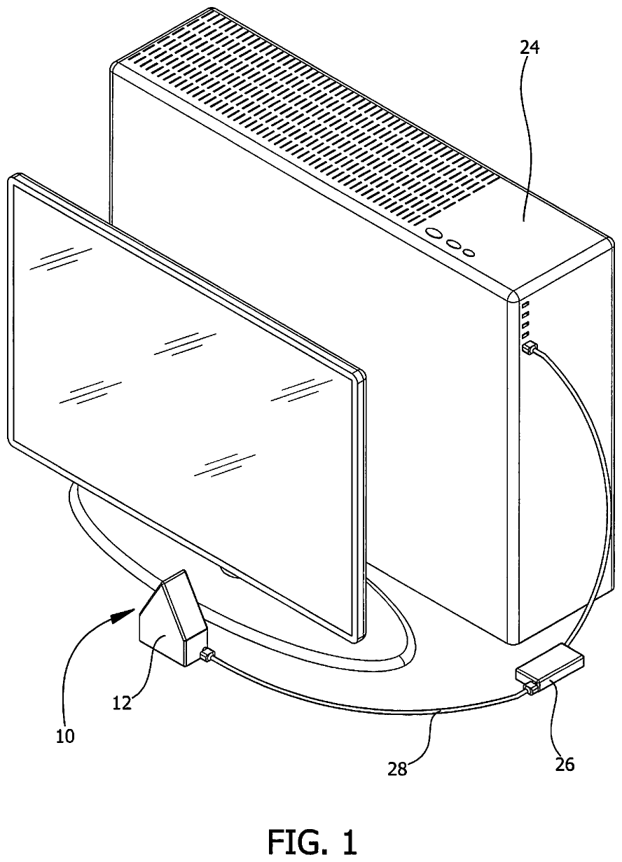

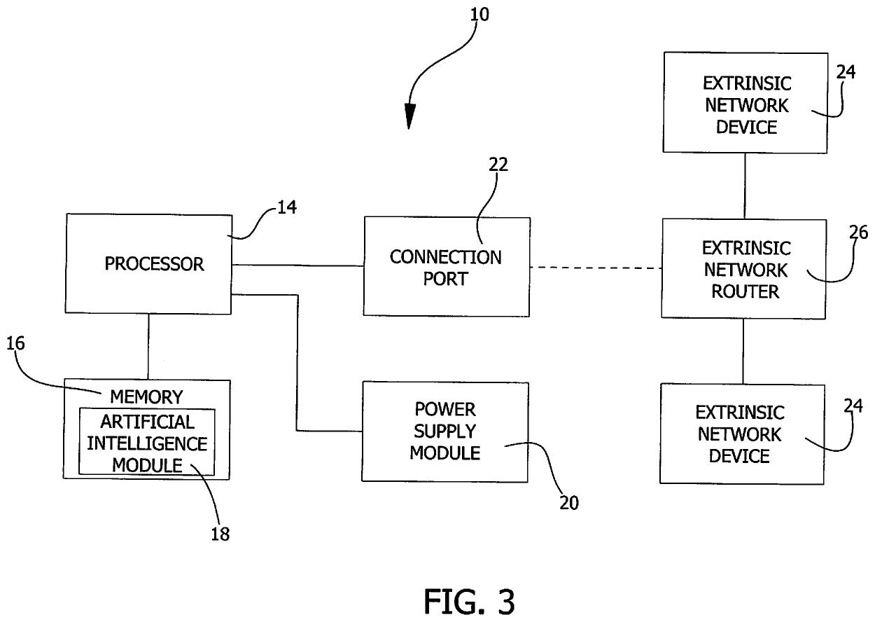

With reference now to the drawings, and in particular to FIGS. 1 through 3 thereof, a new artificial intelligence-based analytical device embodying the principles and concepts of an embodiment of the disclosure and generally designated by the reference numeral 10 will be described.

As best illustrated in FIGS. 1 through 3, the computing device 10 generally comprises a processor 14 and a memory 16 coupled to each other. The memory 16 stores computer-readable instructions that, upon execution by the processor 14, configure the processor 14 to receive business data comprising various business parameters from a plurality of data processing devices 24 and determine, via an artificial intelligence (AI) module 18, a business decision which the AI module 18 predicts will alter at least one of the business parameters to improve performance of a business associated with the business data.

The data processing devices 24 may be computers, mobile phones (e.g., smartphones), servers, tablets, or any other suitable devices. The computing device 10 communicates via a communication network, which may be a local area network (LAN), a wide area network (WAN), a cellular network, or any other suitable network. As depicted in the figures, the communication network uses a router 26, and the computing device 10 couples to the router 26 via an ethernet cord 28. In other embodiments, the computing device 10 may couple to the communication network wirelessly, such as via a Bluetooth protocol, a Wi-Fi protocol, cellular transmission, or the like. In yet other embodiments, the computing device 10 may couple to the communication network via another suitable wired connection.

The AI module 18 is included in the memory 16 but may be a separate component and may have dedicated hardware sufficient to support the processes of the AI module 18. The AI module 18 may use one or more of various techniques to facilitate its decision making, including probabilistic methods, neural networks, and any other suitable method. The AI module 18 may be trained on. The business parameters may contain information of myriad types, such as accounting and other financial data, personnel and resource data, and any other suitable data which may be pertinent to reaching business goals. Key performance indicators of various types may be determined and compared to goal values to assess the performance of the business related to a predicted performance determined by operation of the AI module 18. The business decisions arrived at by the AI module 18 may relate to utilizing resources more efficiently, investing in improving particular resources, or taking any suitable action which may improve the business.

The business decisions may be communicated to relevant individuals via one of the data processing devices 24, by transmitting an email, text message, or similar communication to the relevant individuals, via a display included with the computing device 10, or any other suitable means. In some embodiments, the business decisions may be implemented automatically via one of the data processing devices 24 or other suitable means.

The business data may be obtained from one data processing device 24 or several data processing devices 24. Different pieces of the business data may be obtained from different data processing devices 24. The processor 14 may be programmed via the computer-readable instructions to continuously monitor the plurality of data processing devices 24 for changes to the business data. The processor 14 may further be programmed to determine new business decisions via the AI module 18 based on changes to the business data.

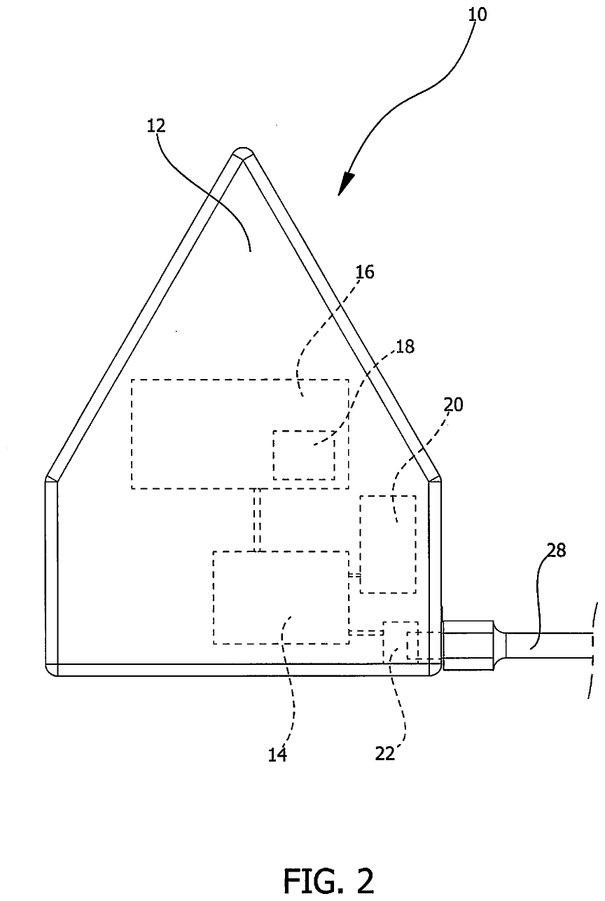

With reference to FIG. 2, an embodiment of the present disclosure is depicted which has a housing 12 for the computing device 10 which houses the processor 14 and the memory 16. The housing 12 also houses a power supply 20 which comprises a battery, though a capacitor or any other suitable power storage may be used. The power supply 20 may be chargeable in some embodiments and replaceable in some embodiments. In other embodiments, the processor 14 is powered by an external power source. A connection port 22 is mounted on the housing 12 which facilitated connection of the processor 14 to the router 26 via the ethernet cord 28. In embodiments with a wireless connection between the processor 14 and the communication network, a transceiver or the like may be used.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A computing device for analyzing business data, the device comprising:
a processor; and
a memory coupled to the processor, the memory storing computer-readable instructions that, upon execution by the processor, configure the processor to:
receive business data comprising various business parameters from a data processing device; and
determine, via an artificial intelligence (AI) module, a business decision which the AI module predicts will alter at least one of the business parameters to improve performance of a business associated with the business data.

2. The device of claim 1, wherein the processor is configured to communicate with the data processing device via a communication network.

3. The device of claim 1, wherein the processor is configured to communicate with each one of a plurality of data processing devices, the processor being configured to receive different pieces of the business data from different data processing devices of the plurality of data processing devices.

4. The device of claim 3, wherein the computer-readable instructions configure the processor to continuously monitor the plurality of data processing devices for changes to the business data, the computer-readable instructions configuring the processor to determine new business decisions via the AI module based on changed business data.

5. The device of claim 1, wherein the computing device comprises a power supply electrically coupled to the processor.

6. The device of claim 5, wherein the power supply comprises a battery.

7. A computing system for analyzing business data, the system comprising:
a data processing device;
an analysis device in communication with the data processing device via a communication network, the analysis device comprising:
a processor; and
a memory coupled to the processor, the memory storing computer-readable instructions that, upon execution by the processor, configure the processor to:
receive business data comprising various business parameters from the data processing device; and
determine, via an artificial intelligence (AI) module, a business decision which the AI module predicts will alter at least one of the business parameters to improve performance of a business associated with the business data.

8. The device of claim 7, wherein the data processing device is one of a plurality of data processing devices, the processor being in communication with each data processing device of the plurality of data processing devices via the communication network, the processor being configured to receive different pieces of the business data from different data processing devices of the plurality of data processing devices.

9. The device of claim 8, wherein the computer-readable instructions configure the processor to continuously monitor the plurality of data processing devices for changes to the business data, the computer-readable instructions configuring the processor to determine new business decisions via the AI module based on changed business data.

10. A computer-implemented method of analyzing business data comprising:
receiving, via a processor, business data comprising various business parameters from a data processing device; and
determining, via an artificial intelligence (AI) module, a business decision which the AI module predicts will alter at least one of the business parameters to improve performance of a business associated with the business data.

11. The method of claim 10, wherein the processor communicates with the data processing device via a communication network.

12. The method of claim 10, wherein the step of receiving the business data comprises receiving different pieces of the business data from different data processing devices of a plurality of data processing devices.

13. The method of claim 12, further comprising:
continuously monitoring the plurality of data processing devices for changes to the business data; and
determining new business decisions via the AI module based on changed business data.
